(19) United States
(12) Patent Application Publication
(10) Pub. No.: US 2025/0180286 A1
(43) Pub. Date: Jun. 5, 2025

(54) SOLVENT RECOVERY DEVICE

(71) Applicant: TOYOTA JIDOSHA KABUSHIKI KAISHA, Toyota-shi (JP)

(72) Inventors: Kenichiro MURAMATSU, Toyota-shi (JP); Yasushi KATO, Toyota-shi (JP); Junichi ISHIMOTO, Okazaki-shi (JP); Kazuki NORITAKE, Nisshin-shi (JP)

(21) Appl. No.: 18/796,222

(22) Filed: Aug. 6, 2024

(30) Foreign Application Priority Data
Dec. 1, 2023 (JP) 2023-203891

(51) Int. Cl. F25J 1/02; F25J 1/00

(52) U.S. Cl. CPC F25J 1/0245; F25J 1/0022; F25J 2290/32

(57) ABSTRACT

A solvent recovery device is configured to liquefy and recover a solvent gas from a mixed gas of the solvent gas and a carrier gas. The solvent recovery device includes: a multi-tube heat exchanger; an actuator; and a control circuit. The multi-tube heat exchanger includes a plurality of tubes arranged in parallel through which the mixed gas circulates, and a shell accommodating the plurality of tubes and circulating a cooling medium around the plurality of tubes. The actuator is configured to change a total surface area that is a sum of surface areas of inner walls of a tube or a plurality of tubes through which the mixed gas is brought to flow, among the plurality of tubes. The control circuit is configured to control the actuator to change the total surface area according to a gas concentration of the solvent gas in the mixed gas.

### CROSS-REFERENCE TO RELATED APPLICATION

This application claims priority to Japanese Patent Application No. 2023-203891 filed on Dec. 1, 2023, incorporated herein by reference in its entirety.

### BACKGROUND

### 1. Technical Field

The present disclosure relates to a solvent recovery device that liquefies and recovers a solvent gas.

### 2. Description of Related Art

Japanese Unexamined Patent Application Publication (Translation of PCT application) No. 2013-515228 (JP 2013-515228 A) discloses a device that cools and liquefies natural gas. This device includes a shell and tube heat exchanger that includes a plurality of flow passages through which the natural gas circulates and a shell accommodating the plurality of flow passages. In this device, the number of flow passages through which the natural gas is brought to flow is controlled according to the flow rate of the natural gas.

Japanese Unexamined Patent Application Publication No. 08-159611 (JP 08-159611 A) also discloses a shell and tube condenser applied to a water-cooled refrigeration system. In this condenser, there is adopted a configuration to reduce the density of contact surfaces of heat transfer tubes with a gas cooling medium so as to form the arrangement of the heat transfer tubes in contact with the gas cooling medium near partitioning parts that partition coolant passages in a wave form. Furthermore, Japanese Unexamined Patent Application Publication No. 2013-185770 (JP 2013-185770 A) discloses a heat exchanger having a horizontal shell and tube structure. In this heat exchanger, a part of a low-temperature heat medium transfer space, which corresponds to a heated gas transfer space that is a space inside an outer body where heated gas flows, is provided with a structure to increase the contact area between the heated gas and a low-temperature heat transfer medium in a liquid phase.

### SUMMARY

As described above, in the shell and tube heat exchanger described in JP 2013-515228 A, the number of gas flow passages through which the natural gas is brought to flow is selected based on the flow rate of the natural gas. The shell and tube heat exchanger (multi-tube heat exchanger) can be applied to a solvent recovery device that liquefies and recovers a solvent gas (gasified solvent) from a mixed gas of a solvent gas and a carrier gas. Unfortunately, in the solvent recovery device with the mixed gas as a target, when the number of tubes through which the mixed gas is brought to flow is determined based on only the flow rate of the mixed gas, the condensation efficiency of the solvent gas might become insufficient.

The present disclosure has been made in the light of the above problems and has an object to enhance condensation efficiency of a solvent gas in a solvent recovery device including a multi-tube heat exchanger that is supplied with a mixed gas of a solvent gas and a carrier gas.

A solvent recovery device according to the present disclosure is configured to liquefy and recover a solvent gas from a mixed gas of the solvent gas and a carrier gas. The solvent recovery device includes: a multi-tube heat exchanger; an actuator; and a control circuit. The multi-tube heat exchanger includes a plurality of tubes arranged in parallel through which the mixed gas circulates, and a shell accommodating the plurality of tubes and circulating a cooling medium around the plurality of tubes. The actuator is configured to change a total surface area that is a sum of surface areas of inner walls of a tube or a plurality of tubes through which the mixed gas is brought to flow, among the plurality of tubes. The control circuit is configured to control the actuator to change the total surface area according to a gas concentration of the solvent gas in the mixed gas.

The solvent recovery device according to the present disclosure, it is possible to enhance the condensation efficiency of the solvent gas (i.e. the recovery rate of the solvent) by changing the above-described surface area according to the concentration of the solvent gas in the mixed gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view schematically showing a configuration example of a solvent recovery device according to an embodiment;

FIG. 2 is a view schematically showing another example of a gas-liquid separation structure for discharge fluid;

FIG. 3 is a view explaining a first control example of the number of tubes through which a mixed gas is brought to flow; and

FIG. 4 is a view explaining a second control example of the number of tubes through which the mixed gas is brought to flow.

### DETAILED DESCRIPTION OF EMBODIMENTS

With reference to the accompanying drawings, the embodiments of the present disclosure will be described.

### 1. Configuration of Solvent Recovery Device

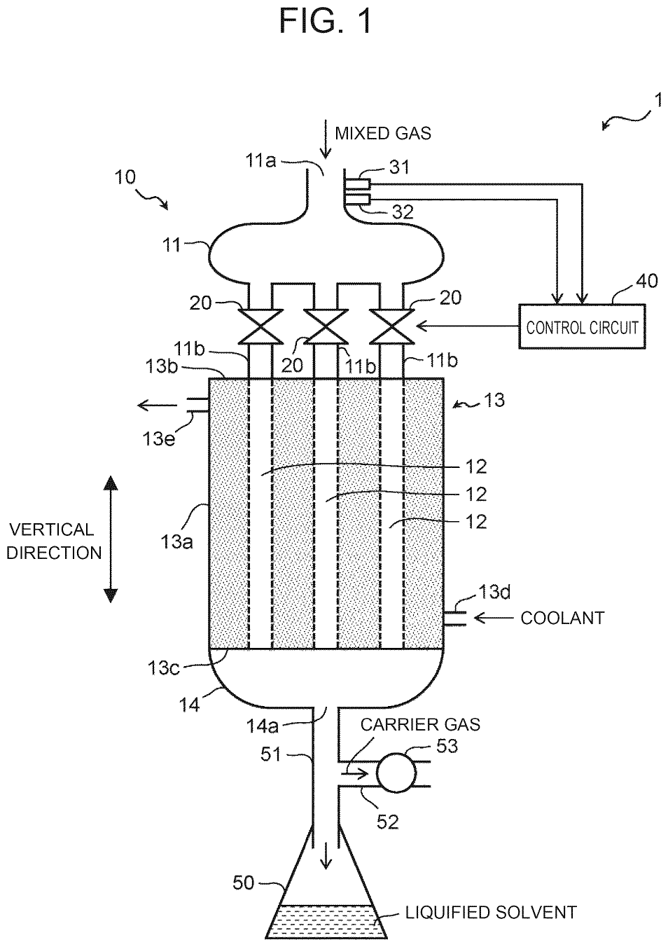

FIG. 1 is a view schematically showing a configuration example of a solvent recovery device 1. The solvent recovery device 1 is configured to liquefy and recover a solvent gas (gasified solvent) from a mixed gas of the solvent gas and a carrier gas. An upward direction on the paper of FIG. 1 corresponds to an upward direction in the vertical direction.

The solvent gas is a gasified gas from an organic solvent (or referred to simply as a solvent) contained in electrolyte of a lithium-ion battery. The solvent includes, for example, a low-boiling solvent such as dimethyl carbonate (DMC) and ethyl methyl carbonate (EMC), and a high-boiling solvent such as ethylene carbonate (EC). An electrode body is impregnated with the electrolyte. The solvent is gasified in a furnace (not shown) during a drying process of the electrode body when the lithium-ion battery is disassembled. The solvent recovery device 1 recovers the solvent gas generated in this drying process through distillation (more specifically, vacuum distillation, for example). The carrier gas is nitrogen, for example.

The solvent recovery device 1 includes: a multi-tube heat exchanger (shell and tube heat exchanger) 10; a plurality of valves 20; a gas concentration sensor 31 and a gas flow rate sensor 32; a control circuit 40; a liquid recovery container 50; a discharge passage 51; a branch passage 52; and a pump 53.

The multi-tube heat exchanger (or referred to simply as the heat exchanger) 10 includes an inlet chamber 11, a plurality of tubes (plurality of heat transfer tubes) 12, a shell 13, and an outlet chamber 14. The inlet chamber 11 has an inlet 11a into which the mixed gas supplied from the furnace flows. The inlet chamber 11 also has a plurality of branch tubes 11b that leads the mixed gas into the plurality of tubes 12, respectively. In the example shown in FIG. 1, the plurality of branch tubes 11b is arranged higher than the plurality of tubes 12 in the vertical direction.

The plurality of tubes 12 is arranged in parallel. The number of tubes 12 is not particularly limited. The tubes 12 are passages for circulating the mixed gas. The shell 13 accommodates the plurality of tubes 12 and is formed to circulate a cooling medium around the plurality of tubes 12. Specifically, the shell 13 includes a body 13a formed, for example, in a cylindrical shape, and a pair of plates 13b, 13c located at each end of the body 13a. The pair of plates 13b, 13c has a plurality of apertures exposing the plurality of tubes 12 to the inlet chamber 11 and the outlet chamber 14, respectively.

The body 13a of the shell 13 has an inlet 13d and an outlet 13e of the cooling medium. The cooling medium flowing inside the shell 13 exchanges heat with the mixed gas flowing in the plurality of tubes 12 via the plurality of tubes 12. The cooling medium is, for example, water. Alternatively, in the case of cooling the liquid recovery container 50 described later by a refrigeration chiller in order to more reliably recover the solvent, antifreeze may be used as the cooling medium, for example. A gas-liquid mixture fluid containing a solvent condensed and liquefied during passing through the plurality of tubes 12 together with a carrier gas flows out into the outlet chamber 14.

The plurality of valves 20 is provided for the respective branch tubes 11b. The valves 20 are, for example, solenoid valves configured to open and close the respective branch tubes 11b. When the valves 20 are opened, the mixed gas is supplied from the inlet chamber 11 into the respective tubes 12 corresponding to the valves 20. The individual valves 20 are opened and closed in response to commands (electrical signals) from the control circuit 40. Therefore, by changing the number of valves 20 controlled to be opened, it is possible to change the number of tubes 12 through which the mixed gas is brought to flow.

Changing the number of tubes 12 through which the mixed gas is brought to flow corresponds to changing a total surface area TSA of the plurality of tubes 12. The total surface area TSA referred to herein is a sum of surface areas of inner walls of one or a plurality of tubes 12 through which the mixed gas is actually brought to flow, among the plurality of tubes 12 provided to the solvent recovery device 1. Thus, the plurality of valves 20 corresponds to an example of an “actuator” according to the present disclosure.

Instead of the method of changing the number of tubes 12 through which the mixed gas is brought to flow in one shell 13, the total surface area TSA may be changed by, for example, the following method. Specifically, in an example of a solvent recovery device including a plurality of shells 13 configured to change the number of shells 13 through which the mixed gas is brough to flow, changing the number of shells 13 through which the mixed gas is brought to flow corresponds to changing the total surface area TSA.

The gas concentration sensor 31 is configured to detect a concentration of the solvent gas in the mixed gas flowing into the multi-tube heat exchanger 10 (hereinafter, also referred to simply as a “gas concentration C”). The gas concentration C is a weight percentage concentration. More specifically, the gas concentration sensor 31 includes one or more gas concentration sensors that detect the gas concentration C of the solvent as a recovery target (e.g. each of DMC, EMC, and EC). As an example, the gas concentration 20 sensor 31 is disposed in the inlet chamber 11. As the gas concentration sensor 31, for example, a potential detecting sensor or a mass spectrometric sensor may be used. In addition, the mass spectrometric sensor is suitable for liquefying and recovering the solvent gas under a reduced pressure below the atmospheric pressure. The gas flow rate sensor 32 is configured to detect a flow rate of the mixed gas flowing into the multi-tube heat exchanger 10. As an example, the gas flow rate sensor 32 is also disposed in the inlet chamber 11.

The control circuit 40 individually controls opening and closing of the plurality of valves 20. The control circuit 40 includes, for example, a switching circuit configured to output electrical signals to open and close the plurality of valves 20 in response to signals output from the gas concentration sensor 31 and the gas flow rate sensor 32. The control circuit 40 also controls the pump 53. The control circuit 40 includes a circuit that controls the pump 53 to operate, for example, when liquefying and recovering the solvent using the heat exchanger 10. In addition, the control of the pump 53 by the control circuit 40 may include control of a flow rate of the carrier gas to adjust a degree of depressurization inside the heat exchanger 10 and inside the furnace connected to this heat exchanger. The operation of the pump 53 is stopped, for example, when the gas concentration C of the solvent as the recovery target detected by the gas concentration sensor 31 drops to or less than a predetermined determination value. In other words, the liquefying and recovering the solvent is terminated.

The liquid recovery container 50 is located more downward than the heat exchanger 10 in the vertical direction. The liquid recovery container 50 is a container for recovering a liquefied solvent condensed by the heat exchanger 10. The discharge passage 51 connects the outlet of the heat exchanger 10 (i.e. the outlet 14a of the outlet chamber 14) to the liquid recovery container 50. The discharge passage 51 is a passage through which discharge fluid (i.e. gas-liquid mixture fluid containing the liquefied solvent and the carrier gas) from the heat exchanger 10 circulates.

The branch passage 52 communicates with the discharge passage 51. More specifically, in the example shown in FIG. 1, the branch passage 52 branches from the discharge passage 51. The branch passage 52 is a passage through which the carrier gas separated from the liquefied solvent circulates. The pump 53 is provided to the branch passage 52. As a result, of the discharge fluid flowing into the discharge passage 51, the liquefied solvent drops by gravity towards the liquid recovery container 50 and recovered therein. In the meantime, by the operating pump 53, the carrier gas contained in the discharge fluid can flow into the branch passage 52 and degassed.

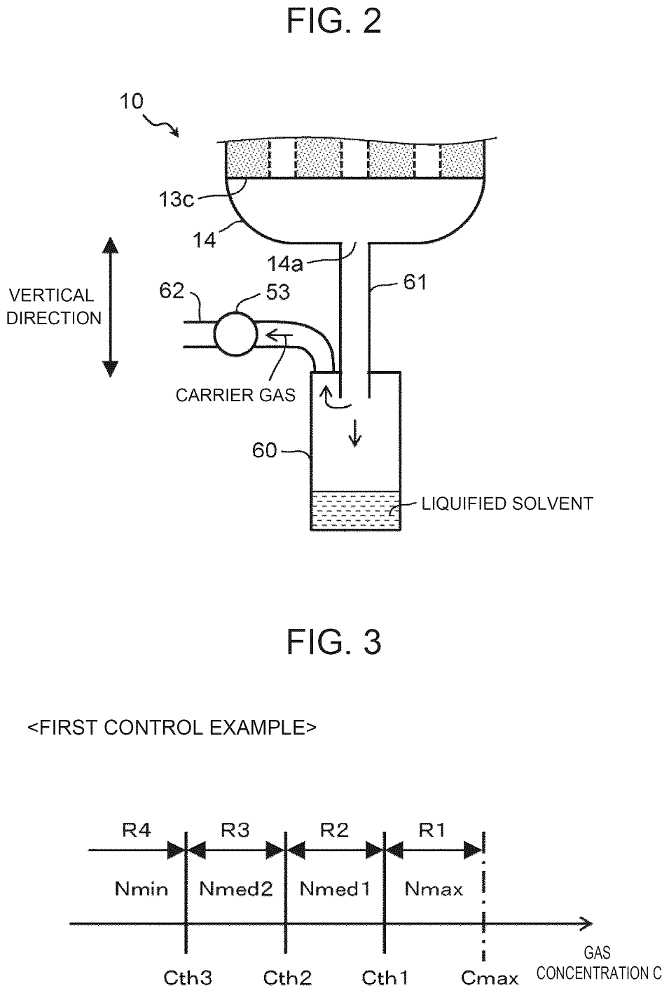

FIG. 2 is a view schematically showing another example of a gas-liquid separation structure of the discharge fluid. The example shown in FIG. 2 differs from the example shown in FIG. 1 in the configurations of a liquid recovery container, a discharge passage, and a branch passage described below. The upward direction on the paper of FIG. 2 corresponds to the upward direction in the vertical direction.

As in the example shown in FIG. 1, in the example shown in FIG. 2, a liquid recovery container 60 is located more downward than the heat exchanger 10 in the vertical direction. In addition, a discharge passage 61 connects the outlet 14a of the heat exchanger 10 to the liquid recovery container 60. On this basis, in the example shown in FIG. 2, a branch passage 62 does not branch from the discharge passage 61 but is connected to an upper wall of the liquid recovery container 60. Also in this example, the branch passage 62 communicates with the discharge passage 61 via the space inside the liquid recovery container 60. The pump 53 is disposed to the branch passage 62. Also in the example shown in FIG. 2, of the discharge fluid that flows into the discharge passage 61, the liquefied solvent is allowed to drop by gravity toward the bottom of the liquid recovery container 60 and recovered therein. In the meantime, the pump 53 is controlled to operate, thereby bringing the carrier gas contained in the discharge fluid to flow into the branch passage 62 and degassed.

### 2. Control of Number (Total Surface Area) of Tubes

The concentration of the solvent gas (the gas concentration C) in the mixed gas flowing into the multi-tube heat exchanger varies during the operation of the solvent recovery device 1. For example, the gas concentration C varies according to variation in amount of the solvent gas generated during the period from the start to the end of generation of the solvent gas in the furnace. The gas concentration C also varies according to change in flow rate of the carrier gas for adjustment of the degree of depressurization.

The diligent research conducted by the inventors has led to the findings that the condensation efficiency of the solvent gas is significantly decreased if the gas concentration C is too low or too high. Therefore, in the solvent recovery device for the mixed gas, as in the solvent recovery device 1 of the present embodiment, if the number of tubes through which the mixed gas is brought to flow is determined based only on the flow rate of the mixed gas, the condensation efficiency might become insufficient.

More precisely, for example, if the number of tubes is increased when the gas concentration C is low and the flow rate of the carrier gas is large, the concentration of the solvent gas per tube might become excessively low. Consequently, the condensation efficiency is significantly decreased. If the number of tubes is reduced when the gas concentration C is high and the flow rate of the carrier gas is small, the concentration of the solvent gas per tube might become excessively high. Also in this case, the condensation efficiency is significantly decreased.

In the light of the above-described problems, in the present embodiment, when the solvent gas is liquefied and recovered from the mixed gas, the control circuit 40 controls the plurality of valves 20 so as to change the number of tubes 12 through which the mixed gas is brought to flow according to the gas concentration C. In other words, the control circuit 40 controls the plurality of valves 20 so as to change the total surface area TSA according to the gas concentration C. More specifically, the control circuit 40 transmits electrical signals to the plurality of valves 20 to control the plurality of valves 20 in the above manner.

Controlling the number of tubes 12 according to the gas concentration C is executed, for example, as in the following first control example and second control example.

### 2-1. First Control Example

FIG. 3 is a view explaining the first control example of the number of tubes 12 through which the mixed gas is brought to flow. In the first control example, the number of tubes 12 is controlled based only on the gas concentration C detected by the gas concentration sensor 31.

Specifically, an assumed maximum concentration value (or referred to simply as a maximum value) Cmax shown in FIG. 3 corresponds to a maximum value of the gas concentration C that is assumed during operation of the solvent recovery device 1. The heat exchanger 10 including the plurality of tubes 12 and the shell 13 is designed to have heat exchange capability of properly condensing the solvent gas under the maximum value Cmax, taking into account the type of the solvent as the recovery target together with the maximum value Cmax.

In the first control example, three threshold values Cth1 to Cth3 are used as a threshold value Cth for the gas concentration C. In FIG. 2, four ranges R1 to R4 of the gas concentration C are identified by the maximum value Cmax and the three threshold values Cth1 to Cth3. In other words, the first concentration range R1 indicates a range that includes the maximum value Cmax (e.g. setting the maximum value Cmax as an upper limit) and is larger than the threshold value Cth1. The second concentration range R2 indicates a range equal to or less than the threshold value Cth1 and larger than the threshold value Cth2. The third concentration range R3 indicates a range equal to or less than the threshold value Cth2 and larger than the threshold value Cth3. The fourth concentration range R4 indicates a range equal to or less than the threshold value Cth3.

When the gas concentration C is within the first concentration range R1, the control circuit 40 controls the plurality of valves 20 to open the maximum number Nmax of tubes 12, i.e., all of the tubes 12. In other words, the control circuit 40 controls the plurality of valves 20 so as to obtain the maximum value of a plurality of values that is selectable as the total surface area TSA.

On the other hand, when the gas concentration C is lower than the first concentration range R1, the control circuit 40 controls the plurality of valves 20 to open fewer number of tubes 12 than the maximum number Nmax of tubes 12, among the plurality of tubes 12. In other words, the control circuit 40 controls the plurality of valves 20 so as to obtain a value less than the above maximum value among the plurality of values that is selectable as the total surface area TSA.

In more detail, in one example shown in FIG. 3, in the second concentration range R2, a first intermediate number Nmed1 of tubes 12 that is fewer than the maximum number Nmax of tubes is opened. In the third concentration range R3, a second intermediate number Nmed2 of tubes 12 that is fewer than the first intermediate number Nmed1 of tubes 12 is opened. In the fourth concentration range R4, a minimum number Nmin of tubes 12 that is fewer than the second intermediate number Nmed2 of tubes 12 is opened. The minimum number Nmin of tubes is not limited to one, and may be at least fewer than the second intermediate number Nmed2 of tubes. The number of threshold values Cth is not limited to three, and may be one or more except for three.

In addition, in each of the threshold values Cth1 to Cth3 of the gas concentration C and in each of the concentration ranges R1 to R4, the number of tubes 12 through which the mixed gas is brought to flow is previously determined so as to maintain the concentration of the solvent gas per tube 12 in a proper range in each of the concentration ranges R1 to R4.

### 2-2. Second Control Example

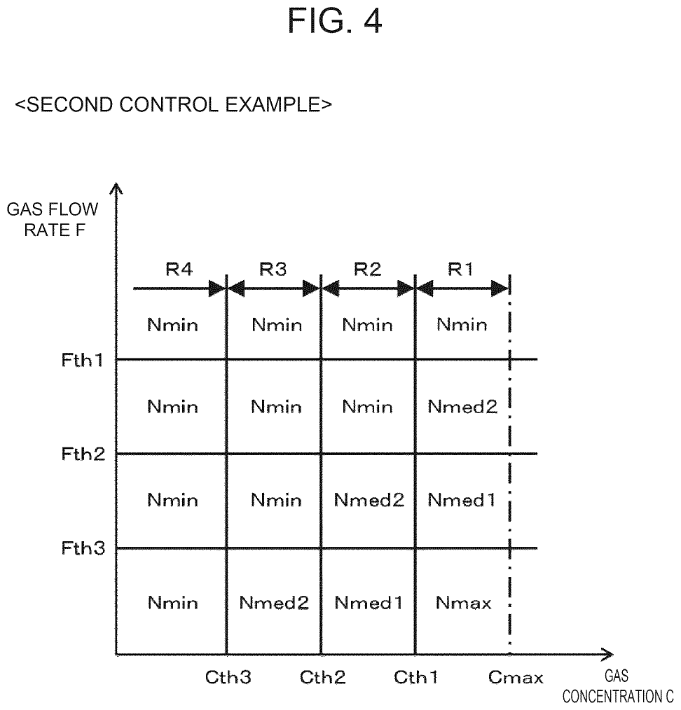

FIG. 4 illustrates a second control example of the number of tubes 12 through which the mixed gas is brought to flow. In the second control example, the number of tubes 12 is controlled based on the gas concentration C detected by the gas concentration sensor 31 together with a gas flow rate F detected by the gas flow rate sensor 32.

Also in the second control example, the three threshold values Cth1 to Cth3 are used as the threshold value Cth of the gas concentration C. In the second control example, three threshold values Fth1 to Fth3 are used as a threshold value Fth of the gas flow rate F. Of the three threshold values Fth1 to Fth3, the threshold value Fth1 is the largest, which is followed by the threshold value Fth2 and the threshold value Fth3 in this order. As with the threshold value Cth, the number of threshold values Fth is not limited to three, and may also be one or more except for three.

In the second control example, although the gas concentration C has the same value, the number of tubes 12 through which the mixed gas is brought to flow may be changed according to the flow rate (gas flow rate F) of the mixed gas flowing into the heat exchanger 10. Specifically, when the gas flow rate F is large although the gas concentration C has the same value, the control circuit 40 might control the plurality of valves 20 to reduce the number of tubes 12 (in other words, to reduce the total surface area TSA), compared to that in the case of having a smaller gas flow rate F.

In one example shown in FIG. 4, when the gas concentration C is within the first concentration range R1 and the gas flow rate F is equal to or less than the threshold value Fth3, the maximum number Nmax of tubes is selected. On the other hand, when the gas flow rate F is larger than the threshold value Fth3 and equal to or less than the threshold value Fth2, the first intermediate number Nmed1 of tubes is selected. When the gas flow rate F is larger than the threshold value Fth2 and equal to or less than the threshold value Fth1, the second intermediate number Nmed2 of tubes is selected. When the gas flow rate F is larger than the threshold value Fth1, the minimum number Nmin of tubes is selected.

In the example shown in FIG. 4, when the gas concentration C is within the second concentration range R2 and when the gas flow rate F is equal to or less than the threshold value Fth3, the first intermediate number Nmed1 of tubes is selected. On the other hand, when the gas flow rate F is larger than the threshold value Fth3 and equal to or less than the threshold value Fth2, the second intermediate number Nmed2 of tubes is selected. When the gas flow rate F is larger than the threshold value Fth2, the minimum number Nmin of tubes is selected.

In the example shown in FIG. 4, when the gas concentration C is within the third concentration range R3 and when the gas flow rate F is equal to or less than the threshold value Fth3, the second intermediate number Nmed2 of tubes is selected. On the other hand, when the gas flow rate F is larger than the threshold value Fth3, the minimum number Nmin of tubes is selected.

In addition, in each of the threshold values Cth1 to Cth3 of the gas concentration C, in each of the threshold values Fth1 to Fth3 of the gas flow rate F, and in each of the concentration ranges R1 to R4, the number of tubes 12 through which the mixed gas is brought to flow is previously determined so as to maintain the concentration of the solvent gas per tube 12 in a proper range in each of the concentration ranges R1 to R4.

### 3. Effects

As described above, according to the solvent recovery device 1 of the present embodiment, the control circuit 40 controls the plurality of valves 20 to change the number (i.e. the total surface area TSA) of tubes 12 through which the mixed gas is brought to flow according to the gas concentration C. As a result, the heat exchange area with the mixed gas in the heat exchanger 10 can be controlled in a proper state under various gas concentrations C. Accordingly, it is possible to improve the condensation efficiency of the solvent gas (in other words, the solvent recovery rate).

More specifically, according to the first control example, when the gas concentration C is within the first concentration range R1, the maximum number Nmax of tubes is selected as the number of tubes 12 through which the mixed gas is brough to flow. On the other hand, when the gas concentration C is lower than the first concentration range R1, a smaller number of tubes 12 than the maximum number Nmax of tubes is selected. In this manner, when the gas concentration C is low, the mixed gas is brought to flow intensively in some tubes 12, thereby properly controlling the concentration of the solvent gas per tube 12 in the light of the condensation efficiency.

According to the second control example, when the gas flow rate F is large although the gas concentration C has the same value, the plurality of valves 20 is controlled to reduce the number (in other words, to reduce the total surface area TSA) of the tubes 12, compared to that in the case in which the gas flow rate F is small. By considering the gas flow rate F and the gas concentration C in this manner, the heat exchange area with the mixed gas in the heat exchanger 10 can be controlled more properly. Accordingly, it is possible to improve the condensation efficiency of the solvent gas more effectively.

The solvent recovery device 1 according to the present embodiment is also provided with the branch passage 52 or 62 communicating with the discharge passage 51 or 61, the branch passage 52 or 62 through which the carrier gas separated from the liquefied solvent circulates. Accordingly, it is possible to carry out degassing of the carrier gas.

Broadly speaking, as far as the number of tubes 12 through which the mixed gas is brought to flow can be changed, the plurality of valves 20 (actuator) may be provided directly to the plurality of tubes 12, for example. In the meantime, in the solvent recovery device 1 according to the present embodiment, the plurality of valves 20 is provided to the respective branch tubes 11b arranged higher than the plurality of tubes (plurality of heat transfer tubes) 12 in the vertical direction. Accordingly, it is possible to change the number of tubes 12 through which the mixed gas is brought to flow by controlling the plurality of valves 20 while preventing liquefied solvent from being accumulated above the closed valves 20.

What is claimed is:

1. A solvent recovery device that liquefies and recovers a solvent gas from a mixed gas of the solvent gas and a carrier gas, the solvent recovery device comprising:
a multi-tube heat exchanger that includes a plurality of tubes arranged in parallel through which the mixed gas circulates, and a shell accommodating the plurality of tubes and circulating a cooling medium around the plurality of tubes;
an actuator that changes a total surface area that is a sum of surface areas of inner walls of a tube or a plurality of tubes through which the mixed gas is brought to flow, among the plurality of tubes; and
a control circuit that controls the actuator to change the total surface area according to a gas concentration of the solvent gas in the mixed gas.

2. The solvent recovery device according to claim 1, wherein the control circuit controls the actuator to obtain a maximum value of a plurality of values that is selectable as the total surface area when the concentration falls within a first concentration range including an assumed maximum concentration value, and to obtain a value smaller than the maximum value of the plurality of values when the concentration is lower than the first concentration range.

3. The solvent recovery device according to claim 1, wherein when the flow rate of the mixed gas flowing into the multi-tube heat exchanger is large although the concentration has the same value, the control circuit controls the actuator such that the total surface area becomes smaller than that when the flow rate is small.

4. The solvent recovery device according to claim 1, further comprising:
a liquid recovery container that is located more downward than the multi-tube heat exchanger in the vertical direction and recovers a liquefied solvent that is condensed by the multi-tube heat exchanger;
a discharge passage that connects an outlet of the multi-tube heat exchanger to the liquid recovery container, and through which discharge fluid containing the liquefied solvent and the carrier gas circulates; and
a branch passage that communicates with the discharge passage, and through which the carrier gas separated from the liquefied solvent circulates.

5. The solvent recovery device according to claim 1, wherein
the multi-tube heat exchanger includes an inlet chamber into which the mixed gas flows,
the inlet chamber includes a plurality of branch tubes that leads the mixed gas into each of the plurality of tubes,
the plurality of branch tubes is arranged higher than the plurality of tubes in a vertical direction, and
the actuator includes a plurality of valves provided respectively for the plurality of branch tubes so as to open and close the respective branch tubes.
